(19) United States
(12) Patent Application Publication
(10) Pub. No.: US 2026/0123657 A1
(43) Pub. Date: May 7, 2026

(54) COMPOSITIONS AND METHODS FOR MASKING OFF-NOTES IN CONSUMABLES

(71) Applicant: GIVAUDAN SA, VERNIER (CH)

(72) Inventors: Yuangang ZHANG, Cincinnati, OH (US); Giulia MALIZIA, Kemptthal (CH); Lisa Maria WIJNEN, Naarden (NL)

(21) Appl. No.: 19/121,892

(22) PCT Filed: Oct. 11, 2023
(86) PCT No.: PCT/EP2023/078224

§ 371 Date: Apr. 17, 2025

Related U.S. Application Data
(60) Provisional application No. 63/418,077, filed on Oct. 21, 2022.

(51) Int. Cl. A23L 27/00; A23L 13/40; A23L 27/10; A23L 27/20; A23L 27/22; A23L 27/23; A23L 33/185

(52) U.S. Cl. CPC A23L 27/84; A23L 13/428; A23L 27/10; A23L 27/2052; A23L 27/22; A23L 27/23; A23L 27/88; A23L 33/185

(57) ABSTRACT

A masking composition for masking non-animal derived protein off-notes is provided. The making composition includes a) a mixture of a Lamiaceae extract together with vitamin C, the extract and the vitamin C having an admixed ratio of from 1:1 to 1:20; b) one or more peptides; c) an extract obtained or obtainable from a plant of the coffea genus; d) an umami-imparting modifier, and e) one or more masking agents selected from the group consisting of fatty acids, terpenes, carbonyls, sulfur compounds, sweet browns, esters, sweeteners, lactones, juice derivatives and combinations thereof.

### TECHNICAL FIELD

The present disclosure relates methods of suppressing off-notes of non-animal derived proteins contained in consumables. More particular, the present disclosure relates to flavor compositions and consumables comprising certain off-note blocking compounds and masking agents that improve the organoleptic properties of chickpea derived protein containing consumables.

### BACKGROUND

The use of non-animal proteins in foodstuffs to replace animal raw materials such as egg or milk, but also meat is becoming increasingly important due to the benefits of protein in the diet. While consumers expect their food and beverage products to have multi-functional benefits, consumers still have high expectations that those products deliver great taste along with efficacy in terms of health benefits. Because each type of protein has its own inherent taste, formulating protein into food and beverage products can produce distinctive tastes perceived as unappealing. For example, products made from plant proteins, e.g., chickpea, display a flavor profile described as grassy, beany, green, earthy, nutty and/or bitter. Chickpea also known as garbanzo beans, is the second most important legume crop around the world. Chickpea is an annual legume crop grown in many countries around the world and a native to the Mediterranean region. Due to its high nutritious value, it became part of the diet in many developing and developed countries around the world. Chickpeas contain vitamin K, folate, phosphorous, zinc, copper, manganese, choline and selenium, as well as high levels of iron, vitamin B-6 and magnesium. Besides being a source of valuable protein, vitamins and minerals, chickpeas are also rich in fiber and low in fat, and have been shown to have health benefits (e.g., lowering cholesterol damage).

Further, food scientists have devoted much time developing methods for preparing acceptable meat-like food applications, such as beef, pork, poultry, fish, and other seafood analogs, from a wide variety of non-animal proteins. One such approach is texturization into fibrous meat analogs, for example, through extrusion processing. The resulting meat analog products exhibit improved meat-like visual appearance and improved texture.

Accordingly, there remains a need for products containing non-animal proteins, for example, chickpea-derived proteins that exhibit improved flavor with reduced off-notes.

### SUMMARY

In one embodiment, a masking composition for masking non-animal derived protein off-notes includes a) a mixture of a Lamiaceae extract together with vitamin C, the extract and the vitamin C having an admixed ratio of from 1:1 to 1:20; b) one or more peptides; c) an extract obtained or obtainable from a plant of the coffea genus; d) an umami-imparting modifier; and e) one or more masking agents selected from the group consisting of fatty acids, terpenes, carbonyls, sulfur compounds, sweet browns, esters, sweeteners, lactones, juice derivatives and combinations thereof.

In another embodiment, a consumable includes a non-animal derived protein: a masking composition comprising a mixture of a Lamiaceae extract together with vitamin C, the extract and the vitamin C having an admixed ratio of from 1:1 to 1:20; one or more peptides; an extract obtained or obtainable from a plant of the coffea genus; an umami-imparting modifier; one or more masking agents selected from the group consisting of fatty acids, terpenes, carbonyls, sulfur compounds, sweet browns, esters, sweeteners, lactones, juice derivatives and combinations thereof; and a flavorant.

In yet another embodiment, a masking composition for masking non-animal derived protein off-notes comprises a) a mixture of a Lamiaceae extract together with vitamin C, the extract and the vitamin C having an admixed ratio of from 1:1 to 1:5; and b) green coffee extract.

These and other features, aspects and advantages of specific embodiments will become evident to those skilled in the art from a reading of the present disclosure.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure relates to the surprising finding that the addition of a masking composition to consumable products comprising non-animal derived proteins makes it possible to provide consumable products with an improved flavor profile due to the suppression or at least reduction of off-notes.

In another embodiment, the present disclosure relates to the surprising finding that the addition of a masking composition, including a mixture of a Lamiaceae extract together with vitamin C, to consumable products comprising non-animal proteins makes it possible to provide consumable products with an improved flavor profile due to the suppression or at least reduction of off-notes.

“Non-animal derived protein” refers to protein preparations made from raw materials including, but not limited to, grain (rice, millet, maize, barley, wheat, oat, sorghum, rye, teff, triticale, amaranth, buckwheat, quinoa): legume or pulses, beans (such as soybean, mung beans, faba beans, lima beans, runner beans, kidney beans, navy beans, pinto beans, azuki beans, and the like), peas (such as green peas, yellow peas, pigeon peas, cowpea, and black-eyed peas and the like), sesame, garbanzo, potatoes, lentils, and lupins: seed and oilseed (black mustard, India mustard, rapeseed, canola, safflower, sunflower seed, flax seed, hemp seed, poppy seed, pumpkin, chia, sesame): nuts (almond, walnut, Brazil, Macadamia, cashews, chestnuts, hazelnuts, pine, pecans, peanuts, pistachio and gingko): algal (kelp, wakame, spirulina, chlorella): mycoprotein and/or fungal protein.

The term “off-note” refers to an unpleasant after taste that develops over time after consumption of consumables.

One of the most important criterion for consumer acceptance of foods is flavor. Proteins have little flavor of their own, but influence flavor perception. Protein ingredients both transmit undesirable off-notes to foods and reduce perceived impact of desirable flavorants. The inventors have surprisingly found that the combination of Lamiaceae extract together with vitamin C have a masking or modifying effect on the undesirable off-note(s) of chickpea derived protein. In response, Applicants have developed a composition that makes it possible to provide non-animal protein ingredients and products containing chickpea-derived proteins with an improved flavor profile with reduced off-notes.

In another embodiment, the inventors have surprisingly found that the combination of Lamiaceae extract together with vitamin C have a masking or modifying effect on the undesirable off-note(s) of non-animal derived protein. In response. Applicants have developed a composition that makes it possible to provide non-animal protein ingredients and products containing non-animal derived proteins with an improved flavor profile with reduced off-notes.

According to the present disclosure, a masking composition may include, a) a mixture of a Lamiaceae extract together with vitamin C, the extract and the vitamin C having an admixed ratio of from 1:1 to 1:20; b) one or more peptides; c) an extract obtained or obtainable from a plant of the coffea genus; d) an umami-imparting modifier; and e) one or more masking agents selected from the group consisting of fatty acids, terpenes, carbonyls, sulfur compounds, sweet browns, esters, sweeteners, lactones, juice derivatives and combinations thereof. The masking composition may also include other optional ingredients for particular applications.

The masking composition of the present disclosure may be used in a wide variety of consumables or applications and is not restricted to any particular physical mode or product form. According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, syrups, aerosols and sprays. The term also refers to, for example, dietary and nutritional supplements. Consumables include compositions that are placed within the oral cavity for a period of time before being discarded but not swallowed. It may be placed in the mouth before being consumed, or it may be held in the mouth for a period of time before being discarded.

Broadly, consumables include, but are not limited to, foodstuffs of all kinds, confectionery products, baked products, sweet products, savoury products, fermented products, dairy products, beverages, oral care products, nutraceuticals and pharmaceuticals.

Exemplary foodstuffs include, but are not limited to, chilled snacks, sweet and savoury snacks, fruit snacks, chips/crisps, extruded snacks, tortilla/corn chips, popcorn, pretzels, nuts, other sweet and savoury snacks, snack bars, granola bars, breakfast bars, energy bars, fruit bars, other snack bars, meal replacement products, slimming products, convalescence drinks, ready meals, canned ready meals, frozen ready meals, dried ready meals, chilled ready meals, dinner mixes, meat analogs, frozen pizza, chilled pizza, soup, canned soup, dehydrated soup, instant soup, chilled soup. UHT soup, frozen soup, pasta, canned pasta, dried pasta, chilled/fresh pasta, noodles, plain noodles, instant noodles, cups/bowl instant noodles, pouch instant noodles, chilled noodles, snack noodles, dried food, dessert mixes, sauces, dressings and condiments, herbs and spices, spreads, jams and preserves, honey, chocolate spreads, nut-based spreads, and yeast-based spreads.

Exemplary confectionery products include, but are not limited to, chewing gum (which includes sugarized gum, sugar-free gum, functional gum and bubble gum), centerfill confections, chocolate and other chocolate confectionery, medicated confectionery, lozenges, tablets, pastilles, mints, standard mints, power mints, chewy candies, hard candies, boiled candies, breath and other oral care films or strips, candy canes, lollipops, gummies, jellies, fudge, caramel, hard and soft panned goods, toffee, taffy, liquorice, gelatin candies, gum drops, jelly beans, nougats, fondants, combinations of one or more of the above, and edible flavour compositions incorporating one or more of the above.

Exemplary baked products include, but are not limited to, alfajores, bread, packaged/industrial bread, unpackaged/artisanal bread, pastries, cakes, packaged/industrial cakes, unpackaged/artisanal cakes, cookies, chocolate coated biscuits, sandwich biscuits, filled biscuits, savoury biscuits and crackers, bread substitutes.

Exemplary sweet products include, but are not limited to, breakfast cereals, ready-to-eat (“rte”) cereals, family breakfast cereals, flakes, muesli, other ready to eat cereals, children's breakfast cereals, hot cereals.

Exemplary savoury products include, but are not limited to, salty snacks (potato chips, crisps, nuts, tortilla-tostada, pretzels, cheese snacks, corn snacks, potato-snacks, ready-to-eat popcorn, microwaveable popcorn, pork rinds, nuts, crackers, cracker snacks, breakfast cereals, meats, aspic, cured meats (ham, bacon), luncheon/breakfast meats (hotdogs, cold cuts, sausage), tomato products, margarine, peanut butter, soup (clear, canned, cream, instant, ultrahigh temperature “UHT”), canned vegetables, pasta sauces.

Exemplary dairy products include, but are not limited to, cheese, cheese sauces, cheese-based products, ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, dairy products, milk, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured, functional and other condensed milk, flavoured milk drinks, dairy only flavoured milk drinks, flavoured milk drinks with fruit juice, soy milk, sour milk drinks, fermented dairy drinks, coffee whiteners, powder milk, flavoured powder milk drinks, cream, yoghurt, plain/natural yoghurt, flavoured yoghurt, fruited yoghurt, probiotic yoghurt, drinking yoghurt, regular drinking yoghurt, probiotic drinking yoghurt, chilled and shelf-stable desserts, dairy-based desserts, soy-based desserts.

Exemplary beverages include, but are not limited to, flavoured water, soft drinks, fruit drinks, coffee-based drinks, tea-based drinks, juice-based drinks (includes fruit and vegetable), milk-based drinks, gel drinks, carbonated or non-carbonated drinks, powdered drinks, alcoholic or non-alcoholic drinks, and ready to drink liquid formulations of these beverages.

Exemplary fermented foods include, but are not limited to, cheese and cheese products, meat and meat products, soy and soy products, fish and fish products, grain and grain products, fruit and fruit products.

In certain embodiments, consumables, for example, meat analogs include a high concentration of chickpea derived protein. The total amount of protein, based on the total weight of the consumable, may be between about 1% by weight and about 20% by weight, or between 2% by weight and about 15% by weight, or between about 2% and about 12% by weight, or between about 3% and about 10% by weight, or between about 4% and about 8% by weight, or between about 5% and about 7% by weight, or any percentage ranges or specific percentages within these ranges.

In accordance with the present disclosure, masking agents are used in combination in order to create compositions suitable for masking or modifying the undesirable off-note(s) in non-animal derived protein, for example chickpea. Masking undesirable flavor notes has been practiced in food and beverage development for many years. Historically, this involved using more sugar or fat to cover bitterness and adjust flavor perception. Flavorists simply “over flavored” their products to hide the offending taste. These traditional methods are wholly unsatisfactory, especially for health-conscious consumers where reduced fat and sugar content is a common goal.

Non-animal derived proteins, for example, chickpea, provide undesirable off-notes. Particularly, undesirable off-notes are the beany, bitter, grassy, astringent, earthy, chalky, and rancid off-notes. The term “off-note” refers to an unpleasant flavour and after taste that develops over time after consumption of consumables. The addition of masking agents will block, mask or modify the off-notes and make them less apparent or unnoticeable. Non-animal derived proteins, for example, chickpea will thereby lose their beany/bitter/grassy/astringent/earthy/chalky/rancid taste.

As used herein, the term “Lamiaceae extract” may refer to an extract from a plant of the Lamiaceae family (Lamiaceae material), such as rosemary, sage, oregano, thyme, mints, and the following genera: Salvia (such as Salvia Apiana and Salvia officinalis), Rosmarinus (such as Rosmarinus officinalis), Lepechinia, Oreganum, Thymus (such as Thymus vulgaris), Hyssopus and mixtures thereof.

The Lamiaceae material used for extracting the Lamiaceae extract can be any part of the plant such as leaves, roots, etc. The Lamiaceae material may be processed before extraction, for example it can be washed, dried, milled or grounded, etc. Particular solvents that may be used in the extraction process include water, alcohols (such as methanol, ethanol), acetone, ethyl acetate, hexane, dichloromethane, and any mixtures thereof, such as alcohol/water mixtures (such as mixtures of methanol and water). For example, the extraction solvents can be water, a water-alcohol mixture (from about 1% to about 99% alcohol in water. For example, from about 30% to about 75% alcohol in water, or from about 30% to about 50% alcohol in water, such as from about 35% or from about 40% alcohol in water), or alcohol. Particular alcohols that may be mentioned include ethanol (EtOH) and methanol (MeOH).

In particular embodiments, the extraction solvent may be a methanol-water mix, such as from about 30% to about 90% methanol in water, or from about 30% to about 50% methanol in water. For example, from about 50% or from about 80% ethanol in water. In a preferred embodiment, the extraction solvent is ethanol-water mix with about 75% methanol and about 25% water.

The term “acetone extract” as used herein, refers to the extract obtained from any member of the Lamiaceae family (such as rosemary, salvia etc) when the extraction from the plant (particularly, leaves) has been performed using acetone as the only solvent. The term “alcohol extract” as used herein, refers to the extract obtained from Lamiaceae when the extraction from the plant (particularly, leaves) has been performed using alcohol as the only solvent. For example, 100% methanol and/or 100% ethanol. The term “hydro-alcoholic extract” as used herein, refers to the extract obtained from Lamiaceae (such as rosemary, salvia etc) when the extraction from the plant has been performed using a mixture of water and alcohol. For example, from about 1% to about 99% alcohol (e.g., ethanol, methanol) in water, such an extract would be termed a hydro-ethanolic extract.

A detailed procedure to prepare a Rosemary extract was described in the U.S. Pat. No. 5,859,293 (PCT WO96/34534), which is incorporated herein by reference in its entirety.

For example, processes for extraction and isolation of extracts of the invention may comprise the following steps:
(i) extraction of Lamiaceae leaves (such as rosemary and/or salvia which may be ground) by a suitable solvent (such as acetone or ethanol);
(ii) evaporation of the solvent; and, if required
(iii) purification of the extract (e.g., by chromatography).

In certain embodiments, the temperature of extraction is in a range of from about 20° C., to about 100° C. In a particular embodiment, the temperature for extraction is in a range of from about 50° C., to about 70° C. Typically, the ratio of plant material to solvent mixture used in the extraction process varies from about 1:1 to about 1:10 on a gram to milliliter basis, such as from about 1:3 to about 1:8. The incubation period (i.e. the period during which the plant material is in contact with the solvent) is typically from about 2 hours to about 24 hours.

Mechanical energy can be applied during the extraction process. Applying mechanical energy helps to homogenize the mixture, changes the physical structure of the starting biological material and increases the extraction yields of phenolic diterpenes. The amount of mechanical energy applied in the method depends on at which step it is applied, the type of Lamiaceae material, the amount of the starting material used in the mixture, the pH of the mixture, and the temperature of the mixture. The amount of mechanical energy also can influence the amount of time needed to complete the extraction process.

For example, the Lamiaceae material (such as rosemary and/or salvia) and the extraction solution (such as acetone or ethanol) may be mixed using techniques known in the art, for example using stirring, maceration, percolation or infusion, such as magnetic or mechanical stirring.

Stirring may be conducted at any suitable revolution per minute (rpm), for example, the stirring may be done from about 1 rpm to about 10 rpm or about 50 rpm to about 500 rpm. For mechanical stirring, this may typically be done from about 1 rpm to 500 rpm, such as from about 10 rpm to about 200 rpm.

Devices for applying mechanical energy can be a pump, a refiner, a homogenizer, an extruder, a lobe pump, and/or a centrifugal pump. The mixture can be circulated in a closed-loop system that includes a pressure vessel (able to contain a heated solvent mixture), a reflux vessel, a heat exchanger, such as a shell and tube heat exchanger, and a pump for recirculating the heated mixture back to the vessel, allowing multiple passes through the pump in the system.

After the Lamiaceae material (such as rosemary and/or salvia leaves) and solvent have been incubated, the solvent is separated from residual Lamiaceae material by any suitable separation technique known in the art (like for example filtration).

Further filtration steps can be used. The solvent may be partially or totally removed by any method known in the art such as centrifugation, Rota vap, and any device allowing solvent evaporation or a liquid-liquid way of replacing the solvent.

Further filtration steps can be used. For example, in one embodiment, aqueous sodium carbonate (Na₂CO₃) may be added to dissolve carnosic acid and other organic acids, while base insoluble substances are precipitated out. The solution may be filtered to separate from solid, and the filtrate can be further concentrated under reduced pressure. In a further step, after finishing concentration is achieved, phosphoric acid (H₃PO₄) may added and the acid insoluble substances (including carnosic acid, carnosol, and carnosic derivatives) are precipitated from the concentrated solution. Additionally, the result may be filtered, and the solid precipitate may be subsequently separated from liquid and rinsed with water to remove impurities. Sterilisation methods can be applied at any step of extraction.

In certain embodiments, the Lamiaceae extract is enriched in phenolic diterpenes. As used herein, the term “Phenolic diterpenes” may refer to carnosic acid, carnosol, methylcar-nosate, and other phenolic diterpene derivatives (rosmanol, isorosmanol, 11,12-di-O-methyli-sorosmanol, 12-O-methylcarnosic acid, rosmanol-9-ethyl ether, circimaritin, Methylated monooxidized product of carnosic acid, genkwanin, epirosmanol, epiisorosmanol, carnosic acid derivative, epirosmanol ethyl ether, cryptotanshinone) and mixtures thereof.

In one embodiment, the extract obtained or obtainable from a plant of the Lamiaceae family may be present in the composition in an amount of from about 0.0001% to about 0.1%, such as from about 0.0005% to about 0.010% by weight of the composition.

In an embodiment, the masking composition according to the present disclosure may include at least one Lamiaceae extract (such as rosemary and/or salvia extract) comprising at least about 1%, at least about 2%, at least about 3%, at least about 4%, at least about 5%, at least about 6%, at least about 7%, at least about 8%, at least about 9%, at least about 10%, at least about 15%, at least about 20%, of one or more phenolic diterpenes such as the ones described before. In one embodiment, the Lamiaceae extract(s) of the composition of the present disclosure comprises carnosic acid and/or carnosol. In certain embodiments, the composition may comprise from about 1% to about 10% by weight of the final composition of carnosic acid, such as about 8%.

According to the present disclosure, the Lamiaceae extract is combined with vitamin C. Vitamin C is a water-soluble vitamin necessary for normal growth and development, as it is required for the growth and repair of body tissues. For example, it is necessary to form collagen and cartilage (an important protein used to make skin, scar tissue, tendons, ligaments, and blood vessels). Vitamin C is also an antioxidant that slows down damage caused by free radicals. Antioxidants remove destructive free radicals from the body before they cause tissue damage that can lead to chronic diseases like heart disease and cancer. Vitamin C may be present in the compositions disclosed herein as ascorbic acid. The compositions disclosed herein may comprise vitamin C in an amount of from about 0.0001% to about 0.2%, such as from about 0.005% to about 0.2% by weight of the composition.

In certain embodiments, the masking composition may comprise a mixture of the Lamiaceae extract (such as rosemary extract) and vitamin C and the admixed ratio between the extract and vitamin C of from 1:1 to 1:20, such as 1:10, 1:5 or 1:2.

According to one embodiment, suitable masking agents for use in accordance with the present disclosure include peptide materials. In one embodiment, the term “peptide material” is understood to indicate a protein hydrolysate and may contain all types of peptides that may vary in length as well as a certain amount of free amino acids resulting from the hydrolysis. The protein raw material is hydrolyzed by one or more hydrolytic enzymes. In one example, enzyme preparations are used which have a low exo-peptidase activity to minimise the liberation of free amino acids and to improve taste profiles of the protein hydrolysates. In one embodiment, the peptide material has a molecular weight of from about 150 to about 10,000 daltons and in another embodiment from about 200 to about 5,000 daltons. Further, the peptide material may be present in an amount from about 0.0001% to about 0.5%, in another embodiment from about 0.0005% to about 0.2%, in another embodiment from about 0.05% to about 0.5%, in another embodiment from about 0.1% to about 0.2%, or any individual number within the ranges, by weight of the masking composition. In one example, the peptide material may be derived from pea protein. In another example, the peptide material may be derived from rice protein. In another example, the peptide material may be derived from soy protein.

In certain embodiments, the peptide material is subjected to enzymatic hydrolysis, wherein the peptide is contacted with one or more enzyme(s) under conditions and for a period of time suitable for the enzyme(s) to at least partially break down the peptide. All enzymes should be food grade.

In one embodiment, the enzyme(s) used for enzymatic hydrolysis may, for example, be selected from proteolytic enzymes. Proteolytic enzymes catalyse the hydrolysis of proteins and peptides. Proteolytic enzymes include, for example, proteinases, which hydrolyze proteins to form small peptides, and peptidases, which further hydrolyze small peptides to form amino acids. The proteolytic enzyme(s) may, for example, have endopeptidase activity (attack internal peptide bonds) and/or exopeptidase activity (attack peptide bonds at the end of the protein or peptide such as amino- or carboxypeptidases).

Proteolytic enzymes include, for example, protease, peptidase, glutaminase (e.g., L-glutamine-amido-hydrolase (EC 3.5.1.2)), endoprotease, serine endopeptidase, subtilisin peptidase (EC 3.4.21.62), serine protease, threonine protease, cysteine protease, aspartic acid protease, glutamic acid protease, trypsin, chymotrypsin (EC 3.4.21.1), pepsin, papain, and elastase.

Proteolytic enzymes (EC 3.4 and EC 3.5) are classified by an EC number (enzyme commission number), each class comprises various known enzymes of a certain reaction type. EC 3.4 comprises enzymes acting on peptide bonds (peptidases/proteinases) and EC 3.5 comprises enzymes that act on carbon-nitrogen bonds other than peptide bonds.

Examples for EC 3.4 include, for example, the following: aminopeptidase (EC 3.4.11), dipeptidase (3.4.13), dipeptidyl-peptidase (3.4.14), peptidyl-dipeptidase (3.4.15), serine-carboxypeptidase (3.4.16), metallocarboxypeptidase (3.4.17), cysteine-carboxypeptidase (3.4.18), omegapeptidase (3.4.19), serine-endopeptidase (3.4.21), cysteine-endopeptidase (3.4.22), aspartate-endopeptidase (3.4.23), metalloendopeptidase (3.4.24), threonine-endopeptidase (3.4.25).

Examples for EC 3.5 include, without limitation, proteolytic enzymes that cleave in linear amides (3.5.1), for example, without limitation, glutaminase (EC 3.5.1.2).

Various proteolytic enzymes, suitable for food-grade applications, are commercially available from suppliers such as Novozymes, Amano, Biocatalysts, Bio-Cat, Valey Research (now subsidiary of DSM), EDC (Enzyme Development Corporation), and others. Some examples include: Neutrase®, Alcalase®, Protamex®, and Flavorzyme®, (available from Novozymes): the Promod® series: e.g. 215P, 439L, 523MDP, 782MDP, 845MDP and 903MDP, Flavorpro® 937MDP, 852MDP, 795MDP, 766MDP, 750MDP, P523MDP (available from Biocatalysts); Protin PC10, UmamizymeR, Peptidase R (or 723), protease A, protease M, protease N, protease P, and Thermoase GL30 (available from Amano): Validase® AFP and Validase® FPII (available from Valey Research): Fungal protease, Exo-protease, Papain, Bromelain, and the Enzeco®; series of proteases and peptidases (available from EDC).

The enzymatic hydrolysis will be performed under conditions suitable for all the enzymes involved. As will be apparent to the skilled person, the temperature and pH should be within a suitable range for hydrolysis to occur to the desired degree. The incubation length will vary accordingly, with shorter incubations when conditions are nearer to the optimum conditions. Necessary ions, if required or beneficial for the chosen enzymes may be present. Subjecting the incubated mixture to agitation, for example by stirring (e.g., at 50 to 500 rpm or 100 to 200 rpm) may improve the hydrolysis.

The enzymatic hydrolysis may, for example, be performed at a temperature less than the temperature at which the enzymes denature. The temperature may, for example, be selected to give a desired reaction rate. The enzymatic hydrolysis may, for example, be performed at a temperature ranging from about 35° C., to about 80° C. For example, the enzymatic hydrolysis may be performed at a temperature ranging from about 40° C., to about 75° C., or from about 45° C., to about 70° C.)

The enzymatic hydrolysis may, for example, be performed at a pH at which the enzymes do not denature. The pH may, for example, be selected to give a desired reaction rate. The enzymatic hydrolysis may, for example, be performed at a pH ranging from about 7 to about 8.5, for example from about 7.5 to about 8.5, for example from about 7.9 to about 8.3. The enzymatic hydrolysis may, for example, take place for a period of time ranging from about 1 hour to about 48 hours. For example, the enzymatic hydrolysis may take place for a period of time ranging from about 2 hours to about 48 hours or from about 4 hours to about 36 hours or from about 6 hours to about 24 hours or from about 8 hours to about 16 hours. In one embodiment, the peptide that is subjected to the enzymatic hydrolysis may, for example, be an aqueous slurry. Thus, in certain embodiments, the method may comprise combining the aqueous slurry with water and a buffer solution prior to the enzymatic hydrolysis. In one embodiment, the reaction mixture after incubation was cooled to room temperature and the mixture was submitted to a separation step, for example by centrifugation, so as to recover the supernatant. In accordance with the present disclosure, the supernatant can be either maintained as it is in liquid form or converted into a powder using mild conditions, for example, spray drying or freeze drying.

According to the present disclosure, the masking composition may also include an extract from a plant of the coffea genus. As used herein, the term “coffea genus” may refer to an extract from a plant of the coffea genus including Coffea canephora, Coffea arabica (Arabica), Coffea canephora (Robusta), Coffea liberica (Liberica), etc. Typically, the extract obtained from a plant of the coffea genus may be obtained from the beans of the plant, for example the green beans. The processes for extraction and isolation of extracts obtained from a plant of the coffea genus may be the same as mentioned previously with respect to the plant of the Lamiaceae family.

In one embodiment, the extract obtained or obtainable from a plant of the coffea genus may be present in the composition in an amount of from about 0.0001% to about 0.1%, such as from about 0.0005% to about 0.01% by weight of the composition.

The extract obtained from a plant of the coffea genus may comprise chlorogenic acid in an amount of about 20% or greater by weight of the extract, such as about 30% or about 40% or greater. For example, the amount of chlorogenic acid present in the extract may be from about 20%, 30% to about 60% by weight of the extract, such as from about 45% to about 50% by weight of the extract.

According to the present disclosure, the masking composition may also include an umami-imparting modifier. Umami is a flavour sensation generally associated with Asian cuisine. It has been described as savory or meaty and is characteristic of broths and cooked meats. Furthermore, improved umami taste helps make low salt products more palatable. Umami flavour has traditionally been achieved by the addition of monosodium glutamate (MSG) to foodstuffs. However, some consumers are believed to be adversely affected by glutamate salts, in particularly MSG, and consequently there remains a need for compounds that are not based on glutamate to replace or reduce reliance on such compounds for modifying the umami taste and savoury flavour of consumable products.

Amides of cinnamic acid derivatives and aromatic amines from natural sources have been reported as natural or nature-identical umami-imparting modifiers in US2012308703A1, WO2013000673A1 or WO2014083202A1. Flavour compositions comprising such amides and further substances are disclosed in WO2014095564A1. A particular class of cinnamides that might generate a trigeminal effect is subject of recently published WO2019063069A1. In another embodiment, certain putrescine bisamides and amide ester analogues, namely those of putrescine (butane-1,4-diamine) and 4-aminobutan-1-ol having for example moieties of cinnamic acid, cinnamic acid derivatives, or 4-methoxybenzoic acid on one hand, and tiglic acid ((2F)-2-methylbut-2-enoic acid) on the other hand, can be used as umami-imparting modifiers. In another embodiment, the umami-imparting modifier may be a nucleotide that is a mixture of disodium inosinate and disodium guanylate, available for example from Mitsubishi Corporation Life Sciences under the trademark RIBOTIDE®.

In one embodiment, the umami-imparting modifier may be present in the composition in an amount of from about 0.001% to about 0.08%, such as from about 0.002% to about 0.06% by weight of the composition.

According to the present disclosure, the masking composition may also include one or more masking agents selected from the group consisting of fatty acids, terpenes, carbonyls, sulfur compounds, sweet browns, esters, sweeteners, lactones, juice derivatives and combinations thereof.

According to one embodiment, suitable masking agents for use in accordance with the present disclosure include fatty acids including, but not limited to, nonanoic acid, decanoic acid, dodecanoic acid, tetradecanoic acid, hexadecanoic acid, oleic acid, octanoic acid, 9-decenoic and hexanoic.

In another embodiment, suitable masking agents include carbonyls including, but not limited to, acetone, acetyl propionyl. 2-heptanone. 2-nonanone, 2-undecanone and cis-4-heptenal. In another embodiment, suitable off-note blocking compounds include sulfur, including, but not limited to, isothiocyanates, methyl sulfide, diallyl disulfide, propenyl disulfide, dimethyl sulfide, dimethyl trisulfide and extracts of alliaceous ingredients. In another embodiment, the sulfur components may be found in sulfur containing oils such as, for example, garlic oil, onion oil, mustard oil and horseradish oil.

In another embodiment, suitable masking agents include sweet browns including, but not limited to, maltol, vanillin, cyclopentenolone, furaneol, vanilla extracts, vanilla derivatives, caramel extracts and condensed milk derivatives.

In another embodiment, suitable masking agents include esters including, but not limited to, ethyl cyclohexanoate, ethyl succinate, ethyl lactate, ethyl caprate, ethyl dodecanoate, ethyl myristate, ethyl palmitate and ethyl oleate. In another embodiment, suitable masking agents include sweeteners including but not limited to, steviol glycosides such as rebaudiosides; rebusodide, swingle extract, mogroside V, erythritol, glucosylated steviol glycosides, honey distillates and sugar distillates.

In another embodiment, suitable masking agents include lactones including, but not limited to, gamma decalactone, delta decalactone, delta dodecalactone, gamma undecalactone and massoia lactone. In another embodiment, masking agents include juice derivatives including, but not limited to, strawberry, cucumber, apple, cherry, kiwi and apricot.

According to one embodiment, suitable masking agents for use in accordance with the present disclosure include terpenes including, but not limited to, fenchol, terpineol, caryophyllene, bisabolene, farnoscene and farnesol. In another embodiment, suitable terpenes include, but are not limited to, carotenes (such as, for example, alpha-carotene, beta-carotene, gamma-carotene, delta-carotene, lycopene, neurosporene, phytofluene, phytoene), and xanthophylls (such as, for example, canthaxanthin, cryptoxanthin, aeaxanthin, astaxanthin, lutein, rubixanthin): monoterpenes (such as, for example, limonene, perillyl alcohol): sesquiterpenes (such as, for example, caryophyllene. β-caryophyllene, zingiberene): saponins: lipids including: phytosterols, campesterol, beta sitosterol, gamma sitosterol, stigmasterol), tocopherols (vitamin E), and omega -3, -6, and -9) fatty acids (such as, for example, gamma-linolenic acid); triterpenoids (such as, for example, oleanolic acid, ursolic acid, betulinic acid, moronic acid); alpha-pinenes, cis-beta-ocimenes and bisabolenes (such as alpha-bisabolene and gamma-bisabolene.

In one example, the masking composition may include a masking agent in an amount from about 0.00000001% to about 0.0025%, in another embodiment from about 0.0000001% to about 0.0015%, in another embodiment from about 0.000001% to about 0.001%, in yet another embodiment from about 0.00001% to about 0.0005%, or any individual number within the range, by weight of consumable.

In accordance with another embodiment, the masking composition may include a plurality of masking agents, including, for example, 5, 6, 7, 8, 9, 10, or more masking agents. In some embodiments, the masking composition includes at least five masking agents: in another embodiment at least ten masking agents: in another embodiment at least fifteen masking agents.

In one embodiment, the masking composition may be included in a consumable in an amount from about 0.0005% to about 0.25%, in another embodiment from about 0.005% to about 0.05%, in another embodiment from about 0.01% to about 0.1, or any individual number within the ranges, by weight of consumable.

In one embodiment, the masking composition may, optionally, include a flavorant. By “flavorant” it is meant a composition created by a flavorist using methods known to the skilled person that is a mixture of tastants, aroma compounds and sensates. Examples of suitable flavorants include natural flavors, artificial flavors, spices, seasonings, and the like. Exemplary flavorants include synthetic flavor oils and flavoring aromatics and/or oils, oleoresins, essences, and distillates, and a combination comprising at least one of the foregoing.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavorant include a milk flavor, a butter flavor, a cheese flavor, a cream flavor, and a yogurt flavor, a vanilla flavor, tea or coffee flavors, such as a green tea flavor, an oolong tea flavor, a tea flavor, a cocoa flavor, a chocolate flavor, and a coffee flavor: mint flavors, such as a peppermint flavor, a spearmint flavor, and a Japanese mint flavor: spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; floral flavors; and vegetable flavors, such as an onion flavor, a garlic flavor, a cabbage flavor, a carrot flavor, a celery flavor, mushroom flavor, and a tomato flavor.

According to some embodiments, flavorants may also include aldehydes and esters such as cinnamyl acetate, cinnamaldehyde, citral diethylacetal, dihydrocarvyl acetate, eugenyl formate, p-methylamisol, and so forth can be used. Further examples of aldehyde flavourings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavours), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits). 2-ethyl butyraldehyde (berry fruits), hexenal, i.e., trans-2 (berry fruits), tolyl aldehyde (cherry, almond), veratraldehyde (vanilla). 2,6-dimethyl-5-heptenal, i.e., melonal (melon). 2,6-dimethyloctanal (green fruit), and 2-dodecenal (citrus, mandarin), and the like.

Generally, any flavorant or food additive such as those described in “Chemicals Used in Food Processing”. Publication No 1274, pages 63-258, by the National Academy of Sciences, can be used. This publication is incorporated herein by reference.

The masking composition may include from about 0.01% to about 6.0%, in another embodiment from about 0.1% to about 1.0%, in yet another embodiment from about 0.2% to about 0.5%, or any individual number within the ranges, by weight of a flavorant.

In one embodiment, the masking composition may, optionally, include a taste-modulating portion of cultured filamentous fungi, including e.g., an extracellular taste-modulating portion, extract of, or other taste-modulating portion thereof of a filamentous fungal mycelial liquid (e.g., aqueous) culture, from a filamentous fungi including Cordyceps sinensi. In another embodiment, the cultured filamentous fungi may be a filamentous fungus mycelial aqueous culture, available for example from MycoTechnology. Inc. (Colorado, USA) under the trademark CLEARIQ.

The masking composition obtained by and/or obtainable by the methods described herein may, for example, be added to consumables/food products (e.g., as part of a flavour composition) to improve mouthfeel and/or reduce/mask off-notes of the consumable.

By “masking of off-notes” it is meant that the intensity and/or length of perception of undesirable attributes in a food product is reduced, as analysed by trained panelists when comparing food comprising an ingredient with off-note masking to food without an added off-note masking ingredient.

According to other embodiments, the disclosed method may be used to reduce or eliminate off-notes imparted by non-animal derived protein such as chickpea protein. In one example, the disclosed masking composition may be used to reduce or eliminate off-notes imparted by meat analog products containing chickpea derived protein. “Meat analog” is a food product that approximates the aesthetic qualities and/or chemical characteristics of certain types of meat. The term Meat analogue includes those prepared with textured vegetable proteins (TVP), high moisture meat analogue (HMMA) and low moisture meat analogue (LMMA) products.

The masking composition according to the present disclosure may be added pre or post extrusion in order to reduce or eliminate off-notes imparted by non-animal derived protein such as chickpea protein.

### Meat Analog Composition and Extrusion Process

Food scientists have devoted much time developing methods for preparing acceptable meat-like food applications, such as beef, pork, poultry, fish, and shellfish analogs, from a wide variety of non-animal proteins. One such approach is texturization into fibrous meat analogs, for example, through extrusion processing. The resulting meat analog products exhibit improved meat-like visual appearance and improved texture.

Meat analog products are produced with high moisture content and provide a product that simulates the fibrous structure of animal meat and has a desirable meat-like moisture, texture, mouthfeel, flavor and color.

Texturization of protein is the development of a texture or a structure via a process involving heat, and/or shear and the addition of water. The texture or structure will be formed by protein fibers that will provide a meat-like appearance and perception when consumed. The mechanism of texturization of proteins starts with the hydration and unfolding of a given protein by breaking intramolecular binding forces by heat and/or shear. The unfolded protein molecules are aligned and bound by shear, forming the characteristic fibers of a meat-like product. In one embodiment, polar side chains from amino acids form bonds with linear protein molecules and the bonds will align protein molecules, forming the characteristic fibers of a meat-like product.

To make non-animal proteins palatable, texturization into fibrous meat analogs, for example, through extrusion processing has been an accepted approach. Due to its versatility, high productivity, energy efficiency and low cost, extrusion processing is widely used in the modern food industry. Extrusion processing is a multi-step and multifunctional operation, which leads to mixing, hydration, shear, homogenization, compression, deaeration, pasteurization or sterilization, stream alignment, shaping, expansion and/or fiber formation. Ultimately, the non-animal protein, typically introduced to the extruder in the form of a dry blend, is processed to form a fibrous material.

More recent developments in extrusion technology have focused on using twin screw extruders under high moisture (40-80%) conditions for texturizing non-animal proteins into fibrous meat alternatives. In the high moisture twin screw process, also known as “wet extrusion”, the raw materials, predominantly non-animal proteins such as soy and/or pea protein, are mixed and fed into a twin-screw extruder, where a proper amount of water is dosed in and all ingredients are further blended and then melted by the thermo-mechanical action of the screws. The realignment of large protein molecules, the laminar flow, and the strong tendency of stratification within the extruder's long slit cooling die contribute to the formation of a fibrous structure. The resulting wet-extruded products tend to exhibit improved whole muscle meat-like visual appearance and improved palatability. Therefore, this extrusion technology shows promise for texturizing non-animal proteins to meet increasing consumer demands for healthy and tasty foods.

Texturization processes may also include spinning, simple shear flow, and simple shear flow and heat in a Couette Cell (“Couette Cell” technology). The spinning process consists of unfolding protein molecules in a high alkaline pH solution, and coagulating the unfolded protein molecules by spraying the protein alkaline solution into an acid bath. The spraying is made by a plate with numerous fine orifices. The protein coagulates forming fibers as soon as it gets in contact with the acid medium. The fibers are then washed to remove remaining acid and/or salts formed in the process. A Couette Cell is a cylinder-based device where the inner cylinder rotates and the outer cylinder is stationary, being easy to scale up. The Couette Cell operates under the same principle of forming protein fibers by subjecting the protein to heat and shear in the space between the stationary cylinder and the rotational cylinder.

With respect to simple shear flow and heat in a Couette Cell, this process can induce fibrous structural patterns to a granular mixture of non-animal proteins at mild process conditions. This process is described in “On the use of the Couette Cell technology for large scale production of textured soy-based meat replacers”, Journal of Food Engineering 169 (2016) 205-213, which is incorporated herein by reference.

Meat analog products having qualities (for example, texture, moisture, mouthfeel, flavor, and color) similar to that of whole muscle animal meat may be produced using non-animal proteins formed using extrusion under conditions of relatively high moisture. In one embodiment, meat analog products may include non-animal protein, one or more of flour, starch, and edible fiber, an edible lipid material.

In certain compositions, the amount of non-animal protein included in the mixture to be extruded includes no more than about 90% by weight of the dry ingredients. For example, the amount of non-animal protein present in the ingredients utilized to make meat analog products according to the present disclosure may range from about 3% to about 90% by weight of the dry ingredients. In another embodiment, the amount of non-animal protein present in the ingredients utilized to make meat analog products according to the present disclosure may range from about 10% to about 80% by weight of the dry ingredients. In a further embodiment, the amount of non-animal protein present in the dry ingredients utilized to make meat analog products according to the present disclosure may range from about 25% to about 50% by weight. In another further embodiment, the amount of non-animal protein present in the dry ingredients utilized to make meat analog products according to the present disclosure may be about 40%.

The term “dry ingredients” includes all the ingredients in the mixture to be extruded except for added water and ingredients added with the added water (i.e., the “wet ingredients”).

In addition to the foregoing, the meat analog product includes water at a relatively high amount. In one embodiment, the total moisture level of the mixture extruded to make the meat analog product is controlled such that the meat analog product has a moisture content that is at least about 50% by weight. To achieve such a high moisture content, water is typically added to the ingredients. Although, a relatively high moisture content is desirable, it may not be desirable for the meat analog product to have a moisture content much greater than about 65%. As such, in one embodiment the amount of water added to the ingredients and the extrusion process parameters are controlled such that the meat analog product (following extrusion) has a moisture content that is from about 40% to about 65% by weight.

Among the suitable extrusion apparatuses useful in the practice of the described process is a commercially available double barrel, twin-screw extruder apparatus such as a Wenger TX 52 model manufactured by Wenger (Sabetha. Kansas) or Clextral BC21 model manufactured by Clextral (France).

The screws of a twin-screw extruder can rotate within the barrel in the same or opposite directions. Rotation of the screws in the same direction is referred to as single flow or co-rotating whereas rotation of the screws in opposite directions is referred to as double flow or counter-rotating. The speed of the screw or screws of the extruder may vary depending on the particular apparatus: however, it is typically from about 100 to about 750 revolutions per minute (rpm). Generally, as the screw speed increases, the density of the extrudate will decrease. The extrusion apparatus contains screws assembled from shafts and worm segments, as well as mixing lobe and ring-type shearing elements as recommended by the extrusion apparatus manufacturer for extruding non-animal protein material.

The extrusion apparatus generally comprises a plurality of heating zones through which the protein mixture is conveyed under mechanical pressure prior to exiting the extrusion apparatus through an extrusion die. The temperature in each successive heating zone generally exceeds the temperature of the previous heating zone by between about 10° C., to about 70° C. In one embodiment, the dry premix is transferred through multiple heating zones within the extrusion apparatus, with the protein mixture heated to a temperature of from about 25° C., to about 160° C., such that the molten extrusion mass enters the extrusion die at a temperature of from about 160° C. In one embodiment, the protein mixture is heated in the respective heating zones to temperatures of about 65° C., about 95° C., about 150° C., and about 160° C.

The pressure within the extruder barrel is typically between about 30 psig and about 500 psig, or more specifically between about 50 psig and about 300 psig. Generally, the pressure within the last two heating zones is between about 50 psig and about 500 psig, even more specifically between about 50 psig to about 300 psig. The barrel pressure is dependent on numerous factors including, for example, the extruder screw speed, feed rate of the mixture to the barrel, feed rate of water to the barrel, and the viscosity of the molten mass within the barrel. Water along with additional “wet ingredients” is injected into the extruder barrel to hydrate the non-animal protein mixture and promote texturization of the proteins. As an aid in forming the molten extrusion mass, the water may act as a plasticizing agent. Water may be introduced to the extruder barrel via one or more injection jets. The rate of introduction of water to the barrel is generally controlled to promote production of an extrudate having the aforementioned desired characteristics, such as an extrudate with a moisture content as described above.

### Textured Vegetable Proteins (TVP)/Low Moisture Meat Analogue (LMMA)

Textured vegetable proteins (TVPs) can be defined as food products made from edible protein sources and characterized by having structural integrity and identifiable texture such that each unit will withstand hydration in cooking and other procedures used in preparing the food for consumption. A majority of TVPs produced today are produced by extrusion technology. These TVPs are often rehydrated with 60-65% moisture and blended with other ingredients including, but not limited to, binders, meats, other TVPs, flavours, excipient, fats, oils, or seasonings.

The low-moisture meat analog (LMMA) product is most often cut with an extruder knife at the extruder die to form the finished product size and shape. Drying after extrusion, to remove moisture, improves storage, handling, and shelf-stability. These LMMAs are often rehydrated with 60-70% moisture. Additionally, other food ingredient items can be added to improve finished product functionality and appearance, including, but not limited to, oil, other proteins, salt, seasonings, flavours, maskers, enhancers, or binders. Generally re-hydrated LMMA contains 40-80% moisture, 0-25% oil, 5-30% protein.

A typical formulation of LMMA contains water, protein concentrates, protein isolates, oil, a binder (e.g., cellulose, vital wheat gluten) and flavours, maskers, seasonings, etc, that provide a taste and texture closer to an animal meat product.

### Examples

The following examples are given solely for the purpose of illustration and are not to be construed as limitations of the present invention, as many variations of the invention are possible without departing from the spirit and scope of the present disclosure.

As seen in Table 1 below, three different high-moisture TVP products were prepared. Example 1 was the Control. Example 2 was the Control plus Masker A (combination of inter alia, rosemary extract (carnosic acid 8%) and vitamin C (OnyXen A34, commercially available from Givaudan-Naturex) in a 1:2 ratio, rice peptide, green coffee extract, umami-imparting modifier (UMAMI 421, commercially available from Givaudan), and masking agents); Example 3 was the Control plus Masker B (combination of inter alia, rosemary extract (carnosic acid 8%) and vitamin C (OnyXen A34) in a 1:2 ratio, rice peptide, green coffee extract, umami-imparting modifier (UMAMI 421), masking agents and an ingredient derived from mushroom mycelial fermentation, for example the fermentation of Cordyceps sinensi fungi (CLEARIQ). The chickpea protein ingredient was fed into the extruder, then water was added from a different port on the extruder barrel and oil was added from an additional port on the extruder barrel. The mass was processed in the extruder barrel at high thermal-mechanical stress conditions. Then it exits through a long cooling die and is cut into strips transversal to the flow direction.

Using a bench-top tasting panel (consisting of 12 trained panelists), panelists were asked to record the sensory attribute differences between the Control (Example 1) and illustrative Examples 2 and 3, particularly focusing on off-notes (reduction or differences) and savory notes.

TABLE 1
High Moisture TVP

| | Example 1 | | |
|---|---|---|---|
| Ingredients (g) | (Control) | Example 2 | Example 3 |
| Chickpea protein | 41.5 | 41.4 | 41.4 |
| isolate¹ | | | |
| Chickpea protein | 2.5 | 2.5 | 2.5 |
| concentrate² | | | |
| Salt | 1.0 | 1.0 | 1.0 |
| Masker A | — | 0.3 | — |
| Masker B | — | — | 0.25 |
| Water | 53.5 | 53.5 | 53.5 |
| Vegetable Oil | 1.5 | 1.5 | 1.5 |
| Total | 100 | 100 | 100 |

¹Chickpea Protein 70-C-EU available from AGT Food and Ingredient Inc.
²NUTRAONLY available from Nutraonly Nutritions Inc.

TABLE 2

| Sample | Taste Results |
|---|---|
| Example 1 | Control |
| Example 2 | Less painty, less oxidized, less carboard, |
| | cleaner, less umami, more flavor, less bitter. |
| Example 3 | Less oxidized, less umami/roasted, less earthy. |

From Table 2 above, it can be seen that the samples containing the masking composition according to the present disclosure are found to have less off-notes compared to the Control.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A masking composition for masking non-animal derived protein off-notes comprising:
a) a mixture of a Lamiaceae extract together with vitamin C, the extract and the vitamin C having an admixed ratio of from 1:1 to 1:20;
b) one or more peptides;
c) an extract obtained from a plant of the coffea genus;
d) an umami-imparting modifier; and
e) one or more masking agents selected from the group consisting of fatty acids, terpenes, carbonyls, sulfur compounds, sweet browns, esters, sweeteners, lactones, juice derivatives and combinations thereof.

2. The masking composition according to claim 1, wherein the extract and the vitamin C have an admixed ratio of from 1:1 to 1:5.

3. The masking composition according to claim 1, wherein the Lamiaceae extract is a rosemary extract.

4. The masking composition according to claim 3, wherein the rosemary extract comprises from 1% to 10% by weight of the extract of carnosic acid.

5. The masking composition according to claim 1, wherein the one or more peptides are selected from the group consisting of pea, soy, rice peptides and combinations thereof.

6. The masking composition according to claim 1, wherein the plant of the coffea genus is a green coffee extract.

7. The masking composition according to claim 1, wherein the umami-imparting modifier is selected from the group consisting of monosodium glutamate, ribonucleotides and combinations thereof.

8. The masking composition according to claim 1, wherein the fatty acids are selected from the group consisting of nonanoic acid, decanoic acid, dodecanoic acid, tetradecanoic acid, hexadecanoic acid, oleic acid, octanoic acid, 9-decenoic, hexanoic and combinations thereof.

9. The masking composition according to claim 1, wherein the carbonyls are selected from the group consisting of acetone, acetyl propionyl, 2-heptanone, 2-nonanone, 2-undecanone, cis-4-heptenal and combinations thereof.

10. The masking composition according to claim 1, wherein the sulfur compounds are selected from the group consisting of isothiocyanates, methyl sulfide, diallyl disulfide, propenyl disulfide, dimethyl sulfide, dimethyl trisulfide, extracts of alliaceous ingredients and combinations thereof.

11. The masking composition according to claim 1, wherein the sweet browns are selected from the group consisting of maltol, vanillin, cyclopentenolone, furaneol, vanilla extracts, vanilla derivatives, caramel extracts, condensed milk derivatives and combinations thereof.

12. The masking composition according to claim 1, wherein the esters are selected from the group consisting of ethyl cyclohexanoate, ethyl succinate, ethyl lactate, ethyl caprate, ethyl dodecanoate, ethyl myristate, ethyl palmitate and combinations thereof.

13. The masking compositions according to claim 1, wherein the sweeteners are selected from the group consisting of steviol glycosides, erythritol, glucosylated steviol glycosides, honey distillates, sugar distillates and combinations thereof.

14. The masking composition according to claim 1, wherein the lactones are selected from the group consisting of gamma decalactone, delta decalactone, delta dodecalactone, gamma undecalactone, massoia lactone and combinations thereof.

15. The masking composition according to claim 1, wherein the terpenes are selected from the group consisting of fenchol, terpineol, caryophyllene bisabolene, farnoscene, farnesol and combinations thereof.

16. A consumable comprising:
a non-animal derived protein;
a masking composition comprising a mixture of a Lamiaceae extract together with vitamin C, the extract and the vitamin C having an admixed ratio of from 1:1 to 1:20; one or more peptides; an extract obtained from a plant of the coffea genus; an umami-imparting modifier; and one or more masking agents selected from the group consisting of fatty acids, terpenes, carbonyls, sulfur compounds, sweet browns, esters, sweeteners, lactones, juice derivatives and combinations thereof; and
a flavorant.

17. The consumable according to claim 16, wherein the consumable is a meat analog.

18. The consumable according to claim 16, wherein the non-animal derived protein is a chickpea protein.

19. The consumable according to claim 16, wherein the masking composition is present in an amount from 0.01% to 1.0%, by weight of the consumable.
